(19) United States
(12) Patent Application Publication
(10) Pub. No.: US 2026/0233135 A1
(43) Pub. Date: Aug. 13, 2026

(54) FRONT LOADING FILTER SHOWERHEAD AND METHOD

(71) Applicant: David Farley, Corona, CA (US)

(72) Inventor: David Farley, Corona, CA (US)

(21) Appl. No.: 19/052,108

(22) Filed: Feb. 12, 2025

(51) Int. Cl. B01D 35/04; B01D 29/23; B05B 15/40

(52) U.S. Cl. CPC B01D 35/04; B01D 29/23; B05B 15/40; B01D 2201/301; B01D 2201/4092

(57) ABSTRACT

A showerhead and method of use is configured for use as a rain showerhead and has integrated filtration capabilities that allows easy access to a filter through a center cap in the showerhead face. The showerhead comprises a filter housing with an interior filter cavity with a first end inlet and second open end adapted to receive a filter. The showerhead further comprises a spray housing coupled to and in fluid communication with the filter housing. The filter housing has an engagement element around the second open end that allows a cap to be releasably securable to the filter housing in the center of the shower face. In use, a water filter cartridge is inserted within the filter cavity into a central cavity through an opening and the cap is secured to the filter housing to hold the filter within the showerhead.

### CROSS-REFERENCE TO RELATED APPLICATIONS

Not Applicable

### STATEMENT RE: FEDERALLY SPONSORED RESEARCH/DEVELOPMENT

Not Applicable

### BACKGROUND

### 1. Technical Field

This invention generally relates to filtered showerheads, and, more particularly, to a combination showerhead and integrated filter system and a method for use.

### 2. Related Art

Conventional filtered showerheads may include filters or filter cartridges that are located behind the showerhead. This configuration allows filtered water to run through the showerhead to the user after the water has previously passed through the water filter located behind/upstream of the showerhead.

Although the upstream placement of the filter relative to the showerhead may enable desired filter of the water prior to dispensing through the showerhead, there may be difficulties associated with access to the filter. In particular, when the filter is located behind the showerhead, it may be necessary to remove the showerhead from the shower arm to access the filter, such as for routine maintenance. Additionally, a behind the showerhead filter configuration may limit use with rain showerheads, for example, which protrude into the shower from the ceiling instead of the wall. Disassembling a rain showerhead to replace the filter located behind the shower head may require the user to reach above by means of a ladder which could lead to damage or injury.

Other showerheads with integrated filter systems have been developed, but in such cases the filter is typically located within the showerhead in a manner such that showerhead must be disassembled to gain access to the filter.

In view of foregoing, it is desirable to have a shower filter assembly that has improved compatibility with rain showerheads and other wall mounted showerheads, and allows for simple filter installment, without the need to substantially disassemble the showerhead or otherwise disconnect the showerhead from the shower arm. Various aspects of the present disclosure address this particular need and will be discussed in more detail below.

### BRIEF SUMMARY

In accordance with one embodiment of the present disclosure described herein, there is provided a showerhead configured to enable easy access to an internal filter. The showerhead includes a filter housing comprising a generally cylindrical side wall, the interior of which forms a filter cavity having a generally circular open end adapted to receive at least a portion of the filter. The filter housing includes an inlet fluidly connectable to a fluid source and in fluid communication with the filter cavity, as well as having an engagement element. The showerhead additionally includes a spray housing coupled to and in fluid communication with the filter housing. The spray housing defines a spray pattern through which the water may pass during operation of the showerhead. The showerhead further includes a cap configured to be releasably securable to the engagement element of the filter housing. The cap is configured to conceal the filter when the filter is at least partially received in the filter cavity and the cap is secured to the engagement element.

In operation, a user may remove the center cap from the filter housing to gain access to the filter housing cavity. As such, the user may remove or replace the internal filter easily and re-engage the cap to the filter housing to hold the filter in place. It is also contemplated that the filter may be removed, and the cap replaced, such that the disclosed showerhead may operate without a filter. This provides the user with flexibility to operate the showerhead with or without a filter. Also, because the cap may be located in the center face of the showerhead, this allows the user to more easily access the filter cavity to remove or replace the internal filter. A cap grip or knob may be ergonomically placed on the face of the cap to allow a user to hand loosen or tighten the cap for filter replacement without the need for tools.

The showerhead may include the filter cartridge (e.g., filter) that is adapted to sizably fit into the filter cavity. The filter cartridge may be configured to remove impurities from water passing therethrough. The filter cartridge may be secured within the filter cavity by the cap via securement of the cap to the engagement element of the filter housing.

The inlet of the filter housing may be fluidly connectable to the fluid source via a thread fit. The inlet may be a ball-type connector configured to be positioned within the upper end of the filter housing, wherein the upper end of the filter housing may be socket-type connector.

The engagement element of the filter housing may be a threaded surface, and the cap may have a complementary engagement element wherein the complementary engagement element may be a complementarily threaded surface. Alternatively, the engagement element of the filter housing may be a bayonet-style connector (e.g., a bayonet-configured groove) and the cap may have a complementary engagement element wherein the complementary engagement element is a bayonet-adapted protrusion.

The spray housing may have a multitude of spray outlets. The cap may additionally include a multitude of spray outlets, or alternatively, the cap may be devoid of any spray outlets.

The engagement elements of the cap and filter housing may be configured to include one or more leak channels to facilitate leakage from the edges of the cap if the cap is not properly secured to the filter housing. The water leak may serve as an indicator to the user that the cap needs to be tightened well in advance of the cap becoming so loose that it falls from the showerhead.

According to the present disclosure described herein, there is a method of placing a water filter within a showerhead. The method includes inserting a water filter into a filter cavity of a filter housing. The filter housing includes a generally cylindrical side wall forming the filter cavity having an open end adapted to receive at least a portion of the filter. An inlet is fluidly connectable to a fluid source and in fluid communication with the filter cavity. The filter housing further includes an engagement element. The filter housing is coupled to a spray housing coupled to the filter housing and defining a spray pattern. The method further includes securing a cap adapted to be releasably securable to the engagement element of the filter housing opening to retain and conceal the water filter in the filter cavity.

The step of securing the cap may include facilitating threaded engagement between the cap and the engagement element of the filter housing. The step of securing the cap may include facilitating a bayonet-style engagement between the cap and the engagement element of the filter housing.

The present disclosure will be best understood by reference to the following detailed description when read in conjunction with the accompanying drawings.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 is a perspective view of the disclosed showerhead positioned on a ceiling;

FIG. 1A is a perspective view of the showerhead of FIG. 1 positioned on a wall;

FIG. 2 is a side view of the showerhead of FIG. 1;

FIG. 2A is a side view of the showerhead of FIG. 2, depicting a further embodiment of an alternate design of the cap;

FIG. 3 is a bottom plan view of the showerhead;

FIG. 3A is a bottom plan view of the showerhead of FIG. 3, depicting a further embodiment of an alternate design of the cap;

FIG. 4 is an exploded perspective view of the showerhead;

FIG. 5 is a side cross-sectional view of the showerhead along cross section line 5-5 shown in FIG. 3;

FIG. 6 is a side cross sectional view of the showerhead along the cross-section line 5-5 shown in FIG. 3, depicting the cap not fully secured to the showerhead; and

FIG. 7 is a side cross sectional view of the showerhead of FIG. 5 along cross section line 5-5 shown in FIG. 3, depicting an alternate cap configuration where the cap configuration does not include spray outlets.

Common reference numerals are used throughout the drawings and the detailed description to indicate the same elements.

### DETAILED DESCRIPTION

The detailed description set forth below in connection with the appended drawings is intended as a description of certain embodiments of a device for a filtered showerhead assembly and is not intended to represent the only forms that may be developed or utilized, nor are the described methods the only methods that could be employed. The description sets forth the various structure and/or functions in connection with the illustrated embodiments, but it is to be understood, however, that the same or equivalent structure and/or functions may be accomplished by different embodiments that are also intended to be encompassed within the scope of the present disclosure. It is further understood that the use of relational terms such as first and second, and the like are used solely to distinguish one entity from another without necessarily requiring or implying any actual such relationship or order between such entities.

In some embodiments, the numbers expressing dimensions, quantities, quantiles of ingredients, properties of materials, and so forth, used to describe and claim certain embodiments of the disclosure are to be understood as being modified in some instances by the term “about.” Accordingly, in some embodiments, the numerical parameters set forth in the written description and attached claims are approximations that can vary depending upon the desired properties sought to be obtained by a particular embodiment.

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise.

As used herein, and unless the context dictates otherwise, the term “coupled to” is intended to include both direct coupling (in which two elements that are coupled to each other contact each other) and indirect coupling (in which at least one additional element is located between the two elements). Therefore, the terms “coupled to” and “coupled with” are used synonymously.

Unless otherwise indicated herein, each individual value is incorporated into the specification as if it were individually recited herein. All methods described herein can be performed in any suitable order unless otherwise indicated herein or otherwise clearly contradicted by context. The use of any and all examples, or exemplary language (e.g. “such as”) provided with respect to certain embodiments herein is intended merely to better illuminate the disclosure and does not pose a limitation on the scope of the claimed inventive subject matter. No language in the specification should be construed as indicating any non-claimed element essential to the practice of the inventive subject matter.

It should be apparent to those skilled in the art that many more modifications besides those already described are possible without departing from the inventive concepts herein. The inventive subject matter, therefore, is not to be restricted except in the scope of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced.

The following discussion provides several exemplary embodiments of the inventive subject matter. Although each embodiment represents a single combination of inventive elements, the inventive subject matter is considered to include all possible combinations of the disclosed elements. Various objects, features, aspects and advantages of the inventive subject matter will become more apparent from the following detailed description of preferred embodiments, along with the accompanying drawing figures in which like numerals represent like components.

Referring now to the drawings, wherein the showings are for purposes of illustrating an embodiment of the present disclosure, and are not for purposes of limiting the same, there is depicted a showerhead 10 having an integrated filter. The showerhead 10 may be specifically configured and adapted to facilitate easy access to the filter, such as for routine replacement. The showerhead 10 may include a cap 22 which may be on the face of the showerhead 10 (e.g., the bottom or exposed spraying portion of the showerhead 10), which is more easily accessible than many conventional shower filtration arrangements. For instance, many conventional filters are placed upstream of the showerhead, typically above or behind the showerhead, which makes access to the filter very difficult. By placing the cap 22 in an easy to reach portion of the showerhead 10, a user may more easily gain access to the filter.

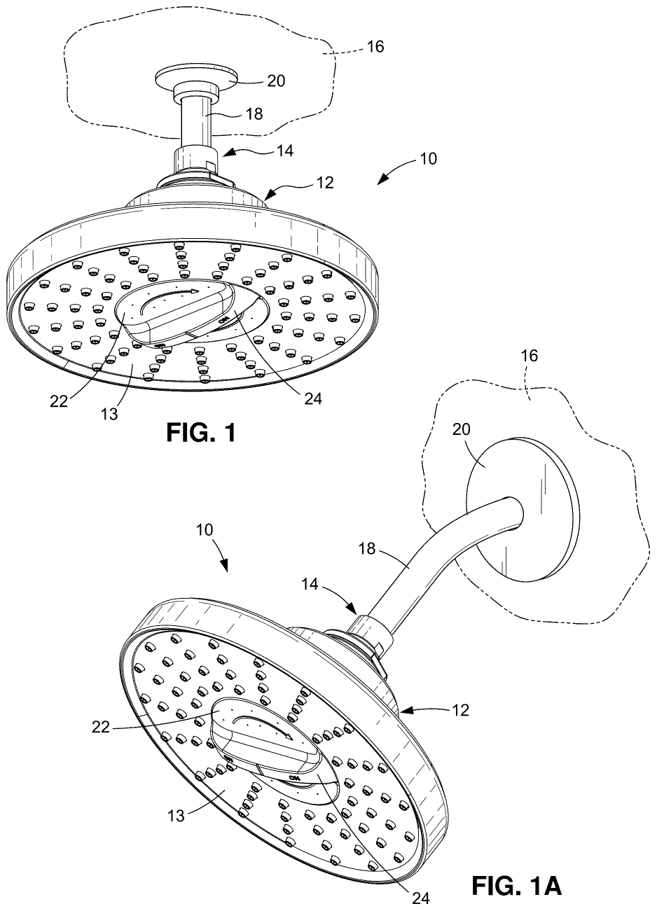

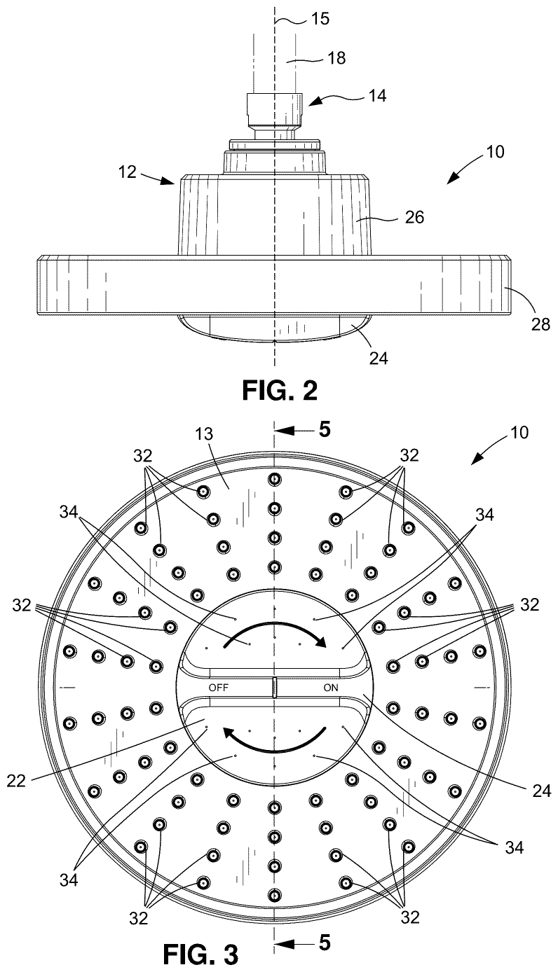

Referring specifically to FIGS. 1 and 1A, there is depicted showerhead 10 generally including a showerhead body configured to retain the water filter, and also generate a desired spray pattern. In this exemplary embodiment, the showerhead body is disposed about a body axis 15 (see FIG. 2) and includes a multi-piece body or housing 12 with a front face or faceplate 13 and a rear connector assembly 14. The showerhead 10 in FIG. 1 is shown as being connected to a ceiling 16, with the faceplate 13 being generally horizontal, while FIG. 1A shows the same showerhead 10 connected to a vertical wall 16, with the faceplate 13 being angled relative to a horizontal plane. In this regard, the structure to which the showerhead 10 may be mounted may vary without departing from the spirit and scope of the present disclosure. The housing 12 is connected to the water source (not shown) via a shower arm 18 which extends from a flange or cover plate 20 located on the ceiling 16 or wall 16 to the rear connector assembly 14. A cap 22 with a knob 24 is releasably securable to the housing 12 and when secured, portions of the cap 22 may be substantially flush with the faceplate 13.

Turing now to FIGS. 2 and 2A, the showerhead 10 is depicted from a side view showing the relationship between the housing 12 and rear connector assembly 14. The exterior portion of the housing 12 generally includes a filter housing 26 (e.g., filter portion) and a spray housing 28 (e.g., spray portion). The spray housing 28 may extend radially outward from the filter housing 26 relative to the central axis 15, with the filter housing 26 and spray housing 28 being aligned along a common central axis. Additionally, the rear connector assembly 14 may be secured to the shower arm 18 using a nut or other fastener known in the art.

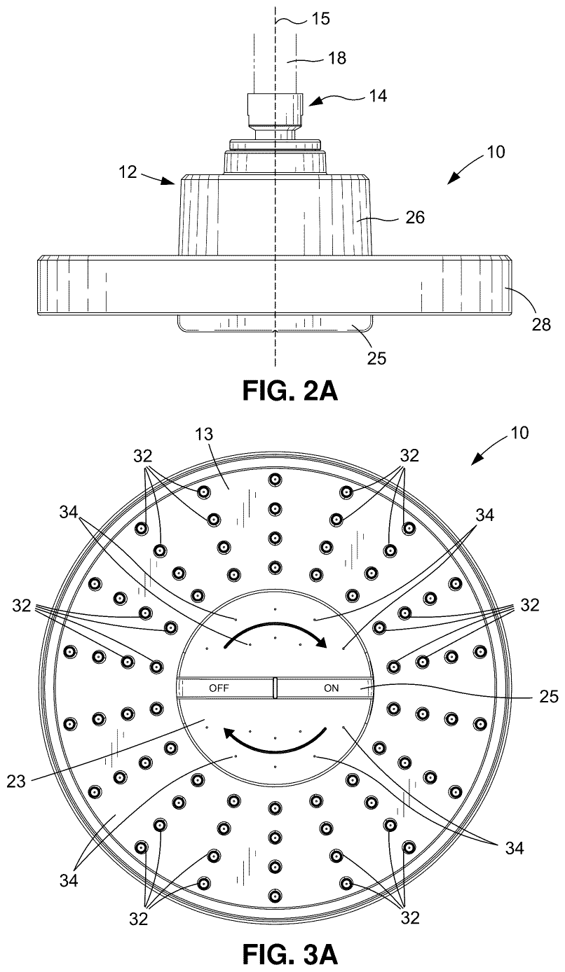

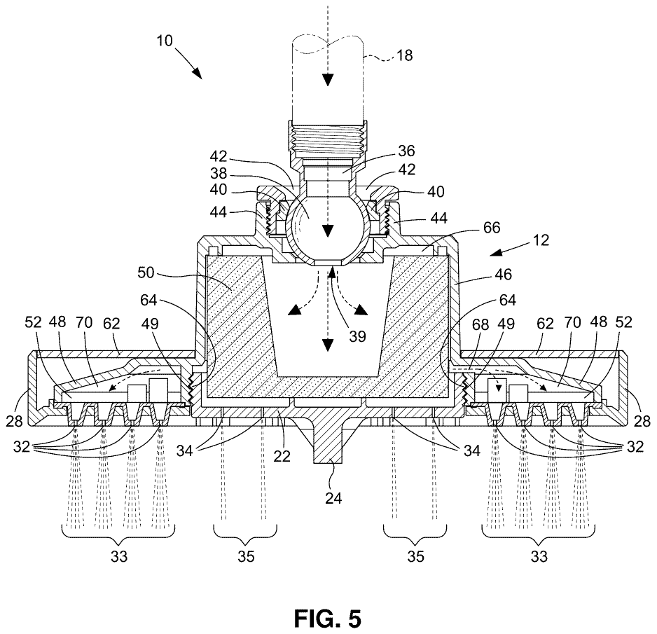

Referring now to FIG. 3, a bottom plan view of the showerhead 10 is provided. The faceplate 13 has a multitude of spray outlets 32 surrounding the cap 22 which is secured in the center of the faceplate 13. The cap 22 may additionally have a multitude of spray outlets 34 for a full spray pattern. The spray openings 34 located on the cap 22 may have a fine mist spray pattern 35 (shown in FIG. 5) while the spray openings 32 located on the faceplate 13 may have a different spray pattern, such as a turbulent flow spray pattern 33 (shown in FIG. 5). In this regard, the spray openings 34 in the cap 22 may be smaller than the spray openings 32 in the faceplate 13. Further, the cap 22 has a knob 24 shown in an arc configuration (e.g., a straight middle segment positioned between curved end portions) to facilitate securing the cap 22 to the housing 12. The arc knob 24 is additionally shown from a side view in FIG. 2. The cap grip or knob 24 is ergonomically placed on the face of the cap 22 (e.g., extends from an external surface of the cap 22) to allow a user to manually loosen or tighten the cap 22 for filter replacement without the need for tools.

FIG. 3A shows an additional embodiment of the cap 23 wherein the knob 25 is shown in a square configuration (e.g., the knob 25 includes generally opposed parallel edges extend along the entirety of the knob 22). Similar to the arc knob 24 shown in FIG. 3, the square knob 25 is used to facilitate securing the cap 23 to the housing 12. A side view of the square knob 25 is shown in FIG. 2A. Although the cap 22 with an arc configuration of the knob 24 and the cap 23 with a square configuration of the knob 25 are alternative embodiments included herein, any analogous configuration known in the art may be used.

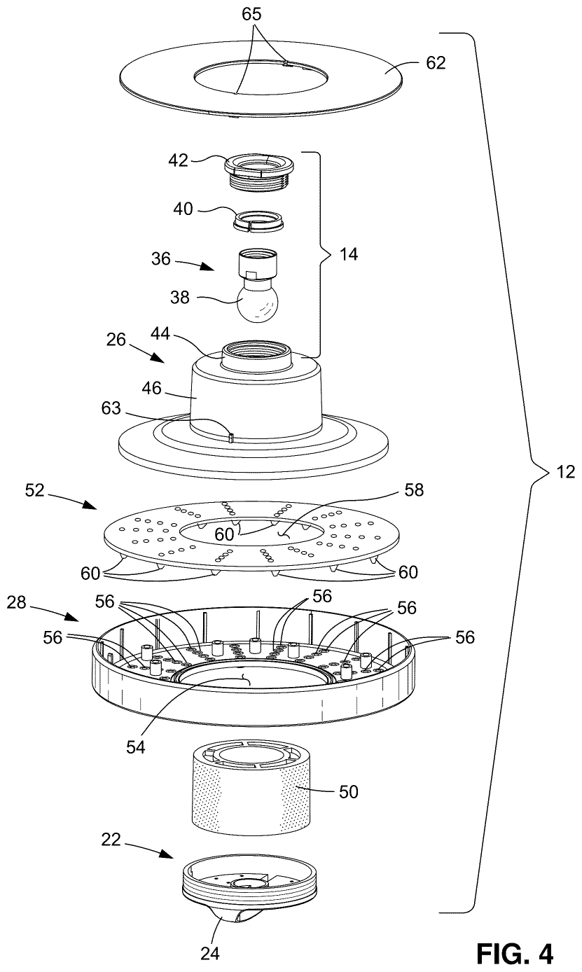

Referring now to FIG. 4, an exploded view of the housing 12 is shown. The shower arm 18 (shown in FIGS. 1 and 1A) may be secured to the inlet 36 via threading located on the internal, upwardly extending sidewalls of the upper portion of the inlet 36 and complementary threading (not shown) on the exterior of the shower arm 18. The shower arm 18 may be further secured to the inlet 36 with a nut or other similar fastener known in the art. The lower portion of the inlet 36 is a ball-type connector 38 that sits within the socket-type connector comprised of the components of the rear connector assembly 14. The water flows through the shower arm 18 through the inlet 36 to a flow opening 39 (shown in FIG. 5) located on the bottom of the ball-type connector 38. The ball-type connector 38 and socket-type connector allow for a degree of rotation for the showerhead 10 and water flow to be angled in different directions by the user. A washer 40 fits over the inlet 36 and rests atop the upper exterior portion of the ball-type connector 38. The washer 40 in the present disclosure is made of a metal material, but it has been contemplated that the washer 40 could be made of a soft, flexible material known in the art, such as rubber or plastic to allow it to also act as a gasket. A collar 42 fits over the upper portion of the inlet 36 and washer 40 and secures to the filter housing 26 via complementary threading located on the exterior sidewalls of the collar 42 and threading located on the upper interior sidewalls of a connector region 44 of the filter housing 26. The inlet 36, washer 40, collar 42, and connector region 44 of the filter housing 26 together make up the rear connector assembly 14, as can be seen first in FIGS. 1 and 1A. The sizing and configuration of the washer 40 and collar 42 relative to the ball-type connector 38 allows for limited rotational movement of the ball-type connector 38 relative to the washer 40 and collar 42 while preventing axial movement of the ball-type connector 38 relative to the washer 40 and collar 42.

According to one embodiment, the filter housing 26 may be disposed about the body axis 15 and generally includes three sections with four diameters that extend outwardly or downwardly from a midpoint located at the center of the topmost point of the connector region 44. The connector region 44 of the filter housing 26 has an outer sidewall that extends downwardly from an upper edge that is of a first diameter until it reaches the midsection 46. The filter housing 26 may include an upper transition wall extending radially outward from the connector region 44 to the midsection 46. The midsection 46 of the filter housing 26 has an outer sidewall that extends outwardly from the first diameter until it reaches a second diameter, then extends continues downwardly until it reaches the lower portion 48. The lower portion 48 of the filter housing 26 has a first segment that extends outwardly from the second diameter, creating a ringlike flat surface. In this regard, the first segment may be generally perpendicular to the midsection 46. Extending radially outward from the first segment may be a generally annular second segment, that may be slightly angled relative to the first segment. The angle of the second segment relative to the first segment may facilitate directed water flow toward the spray openings 32. The outer periphery of the second segment may define a third diameter, greater than the second diameter and first diameter. The lower portion 48 may further include an inner sidewall (see FIG. 5) extending downwardly from the first segment. The inner sidewall may extend generally perpendicular to the first segment and at least partially circumnavigate the body axis 15 and the cavity which holds the filter 50 to define a fourth diameter larger than the first and second diameters, but less than the third diameter. The inner sidewall may include an engagement element 49 (shown in FIG. 5), which may be configured to facilitate attachment to the cap 22, as described in more detail below.

The various sizes and configurations of the different portions of the filter housing 26 are associated with achieving various functionalities. For instance, the first diameter (e.g., inner diameter) of the filter housing 26 allows for the connector region 44 to be releasably securable to the collar 42. The second diameter (e.g., inner diameter) of the filter housing 26 is designed to hold a portion of a filter cartridge 50 within the interior of the midsection 46. The third diameter of the filter housing 26 is designed to sizably fit over a nozzle layer 52 within the spray housing 28. The fourth diameter of the filter housing 26 allows for the engagement element 49 (shown in FIG. 5) to engage the cap 22.

The spray housing 28 may be disposed about a body axis 15. According to one embodiment, the spray housing 28 includes the faceplate 13, which may be a generally planar lower face extending around a central opening 54. A multitude of small openings 56 may be formed in the faceplate 13. The spray housing 28 may additionally include a sidewall extending upwardly from the perimeter of the faceplate 13.

The nozzle layer 52 may extend around the body axis 15 and may be configured to rest within the spray housing 28, generally between the faceplate 13 and the lower portion 48 of the filter housing 26. The nozzle layer 52 includes a large central opening 58 and a plurality of protruding nozzles 60 which are configured to reside within respective ones of the small openings 56 and protrude from the faceplate 13. The small openings 56 of the faceplate 13 and nozzles 60 of the nozzle layer 52 may together make up the spray openings 32 through which water flows out of the showerhead 10. The nozzle layer 52 is preferably formed from a soft, flexible material known in the art such as plastic or rubber. However, the nozzle layer 52 may be formed of metal or other materials known in the art. The central opening 54 of the spray housing 26 and central opening 58 of the nozzle layer 52 may be co-axially aligned with each other and sized to allow the cap 22 to enter and engage with the engagement element 49 of the filter housing 26, and when secured, sit generally flush with the faceplate 13. A generally planar, annular-shaped backplate 62 may be configured to fit over the filter housing 26, rest atop the flat segment of the lower portion 48, and abut the upwardly extending sidewalls of the spray housing 28 to create a uniform exterior appearance of the housing 12. The backplate 62 may be secured to the housing 12 via a complementary press-fit engagement. The present embodiment includes protrusions 63 located on the exterior of the filter housing 26 that lock into depressions 65 on the backplate 62, but another method of securable engagement known in the art may be used.

While the exemplary embodiment shows the filter housing 26, spray housing 28, and nozzle layer 52 as separate structures, it is contemplated that in other embodiments, the filter housing 26, spray housing 28, and nozzle layer 52 may be integrated into a single, integral showerhead body. For instance, the showerhead body may be 3-D printed to achieve a single, integral body having the combined structural attributes of the filter housing 26, spray housing 28, and nozzle layer 52.

Turning now to FIG. 5, a cross-sectional view of the housing 12 is shown, with the cross-section being taken along line 5-5 shown in FIG. 3. In order for the cap 22 to be releasably securable to the housing 12, the lower portion 48 of the filter housing 26 has inner sidewalls having engagement element 49, while the cap 22 has a complementary engagement element 64. The engagement elements 49, 64 may be complementary threaded surfaces or bayonet-style fasteners, or other fastening structures known in the art. The cap 22 in the present embodiment may be secured to the housing 12 by turning the knob 24 in a clockwise direction until the cap 22 is substantially flush with the faceplate 13.

While the exemplary embodiments are associated with the cap 22 being rotatably engageable with the housing 12, it is also contemplated that the cap 22 may be engageable with the housing 12 via non-rotatable engagement. For instance, in other embodiments, the cap 22 may be engageable with the housing via linear engagement, i.e., push-button engagement.

The central interior of the filter housing 26 may comprise the filter cavity 66. The cap 22 may be configured to seal off the filter cavity 66 by securing the complementary engagement element 64 to the engagement element 49 of the filter housing 26. The filter cartridge 50 is configured to sizably fit within the filter cavity 66 when the cap 22 is secured so that water passing through the filter cartridge 50 can be purified before it exits the showerhead 10. When the filter cartridge 50 is in the filter cavity 66 and the cap 22 is secured to the housing 12, the filter cartridge 50 may be retained within the filter cavity 66. The cap 22 may include a stand (e.g., an annular extension) or small risers to slightly space the filter cartridge 50 away from the primary inner surface of the cap 22 to which the spray openings 34 extend to ensure a more uniform fluid flow. In this regard, filtered water can accumulate in the resultant gap between the filter cartridge 50 and the spray openings 34 to ensure constant flow through the spray openings 34. The cap 22 being releasably securable to the housing 12, allows for easy access to the filter cavity 66 so that the filter cartridge 50 may be easily installed or removed. This functionality can minimize risk and required effort for the user when installing or replacing a filter cartridge 50 as the showerhead 10 does not need to be disassembled or removed. Additionally, the cap 22 and the filter cartridge 50 being separable elements allows for the showerhead 10 to function as a standard non-filtered showerhead if no filter cartridge 50 is installed within the filter cavity 66. In this regard, if the cap 22 is secured to the housing 12 without a filter cartridge 50 in the filter cavity 66, the cap 22 may provide a surface opposite the flow opening 39 to create a fluid flow through the shower head 10 such that the water may only exit the shower head 10 though the desired spray openings.

The inner sidewalls of the lower portion 48 of the filter housing 26 may include one or more openings to individually or collectively create a radial/lateral/outward passage 68 from the filter cavity 66 into the spray chamber 70. The area between the lower portion 48 of the filter housing 26, including the area between the inner sidewalls and outer lip, and the nozzle layer 52 make up the spray chamber 70. Water initially flows out of the flow opening 39 and into the filter cavity 66 in a direction generally parallel to a central axis about which the showerhead 10 is disposed. From the filter cavity 66, the water flows radially outward relative to the central axis through the passage 68 to the spray chamber 70 before flowing out of the showerhead 10 through the spray openings 32. The holes placed around the perimeter of the lower portion 48 to create the passage 68 are asymmetrically placed, as shown in FIG. 5 (e.g., in the cross section depicted in FIG. 5 a single passage 68 is shown on the right-hand side, but not on the left-hand side), but could alternatively be symmetrically placed.

FIG. 5 shows the path of water flow through the showerhead 10, and generally follows the same path with or without a filter cartridge 50 present within the filter cavity 66. The water first flows from the fluid source (not shown) through the shower arm 18, then into the inlet 36 and through the flow opening 39, into the filter cavity 66. The water then flows through the filter cartridge 50, if it is present, removing impurities from the water. The water then either flows downwardly through the spray openings 34 located in the cap 22, exiting the showerhead 10 in a fine mist spray pattern 35, or outwardly through the passage 68, into the spray cavity 70, and through the spray openings 32, exiting the showerhead 10 in a turbulent spray pattern 33.

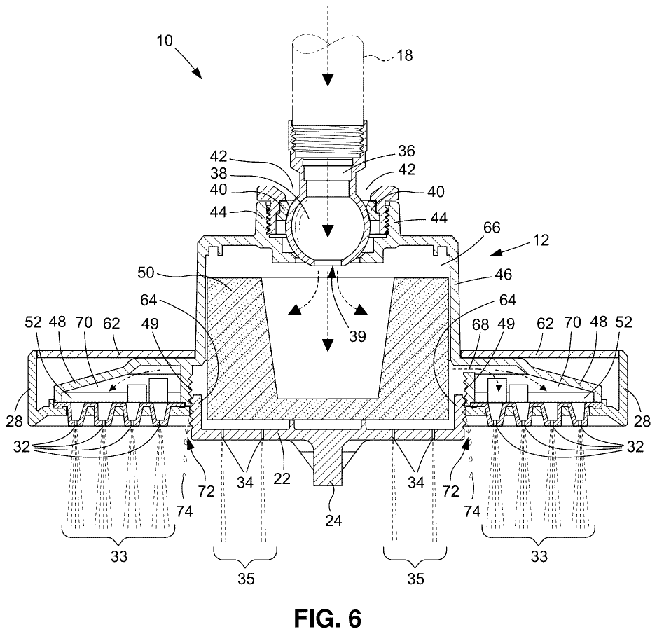

FIG. 6 generally shows the same path of water flow through the showerhead 10 as FIG. 5, but additionally shows water leakage 74 that will occur if the cap 22 is not properly or completely secured to the filter housing 26. If the cap 22 is not properly or fully secured to the filter housing 26, a leak channel 72 formed on an outer periphery of the cap 22 may be exposed to enable water to leak out of the filter cavity 66 into the shower. The leak channel 72 may be a small groove extending parallel to a central axis, about which the cap 22 is disposed, with the small groove forming a minor disruption of the external threads on the cap 22. In this regard, the groove is small enough so as not to defeat the functionality of the threads on the cap 22. The appearance of this leak 74 may cause the user to correctly assume that the cap 22 is not properly or fully secured, and may prompt the user to fully secure the cap 22. This feature may minimize injury or damage caused by the filter cartridge 50 and cap 22 falling into the shower or onto the user because the user was not alerted to the improperly or loosely secured cap 22.

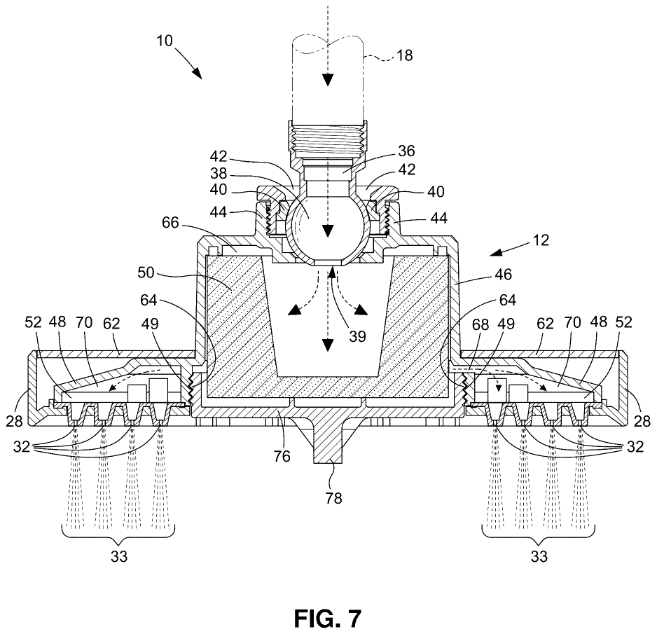

FIG. 7 generally shows the same path of water flow through the showerhead 10 as FIG. 5, but shows an additional embodiment of a cap 76 with an arc knob 78 that contains no exit holes. In this case, after the water flows through the filter cartridge 50 or filter cavity 66, all of the water will then flow through the passage 68, into the spray cavity 70, and out of the spray openings 32 located on the faceplate 13, having only a turbulent spray pattern 33.

The above description is given by way of example, and not limitation. Given the above disclosure, one skilled in the art could devise variations that are within the scope and spirit of the invention disclosed herein, including various ways of assembling and using a filtered showerhead. Further, the various features of the embodiments disclosed herein can be used alone, or in varying combinations with each other and are not intended to be limited to the specific combination described herein. Thus, the scope of the claims is not to be limited by the illustrated embodiments.

What is claimed is:

1. A showerhead configured to enable easy access to an internal filter, the showerhead comprising:
a filter housing comprising:
a generally cylindrical side wall forming a filter cavity having a generally circular open end adapted to receive at least a portion of a filter;
an inlet fluidly connectable to a fluid source and in fluid communication with the filter cavity; and
an engagement element;
a spray housing coupled to the filter housing and in fluid communication with the filter cavity, the spray housing defining a spray pattern; and
a cap configured to be releasably securable to the engagement element of the filter housing opening, the cap being configured to conceal the filter when the filter is at least partially received in the filter cavity and the cap is secured to the engagement element.

2. The showerhead of claim 1, wherein the cap is opposite the inlet of the filter housing.

3. The showerhead of claim 1, wherein the cap includes a protruding knob configured to facilitate movement of the cap relative to the engagement element.

4. The showerhead of claim 1 wherein the inlet includes threads to facilitate engagement to the fluid source.

5. The showerhead of claim 1 wherein the inlet includes a ball-in-socket-type connector.

6. The showerhead of claim 1 wherein the engagement element includes a threaded surface.

7. The showerhead of claim 1 wherein the filter housing and spray housing are separate structures.

8. The showerhead of claim 1 wherein the cap includes an exterior side wall sized to be complementary to the engagement element.

9. The showerhead of claim 8 wherein the exterior side wall includes a threaded surface being complementary to a threaded surface on the engagement element.

10. The showerhead of claim 1 wherein the spray housing includes at least one spray outlet defining the spray pattern.

11. The showerhead of claim 1 wherein the cap includes at least one spray outlet.

12. The showerhead of claim 1, wherein the cap includes at least one leak channel configured to enable liquid flow therethrough when the cap is not properly secured to the filter housing.

13. A showerhead configured to enable easy access to an internal filter, the showerhead comprising:
a filter configured to remove impurities from fluid flowing therethrough;
a showerhead body extending around a body axis, the showerhead body comprising:
a filter cavity disposed about the filter axis and having an open end adapted to receive at least a portion of the filter;
an inlet fluidly connectable to a fluid source and in fluid communication with the filter cavity;
a sprayer portion in fluid communication with the filter cavity and defining a spray pattern; and
an engagement element extending at least partially around the filter axis; and
a cap configured to be releasably securable to the engagement element of the filter housing, the cap being configured to conceal the filter when the filter is at least partially received in the filter cavity and the cap is secured to the engagement element.

14. The showerhead of claim 13, wherein the cap is opposite the inlet of the showerhead body.

15. The showerhead of claim 13, wherein the cap includes a protruding knob configured to facilitate movement of the cap relative to the engagement element.

16. The showerhead of claim 13, wherein the cap is configured to support the filter such that portions of a lower surface of the filter are spaced from the cap.

17. The showerhead of claim 13, wherein the showerhead body includes a filter housing defining the filter cavity and a spray housing engageable with the filter housing and defining the sprayer portion.

18. A method of placing a water filter within a showerhead, the method comprising the steps of:
inserting a water filter into a filter cavity of a filter housing, the filter housing comprising:
a generally cylindrical side wall forming the filter cavity having a generally circular open end adapted to receive at least a portion of the filter;
an inlet fluid connectable to a fluid source and in fluid communication with the filter cavity; and
an engagement element;
the filter housing being coupled to a spray housing in fluid communication with the filter housing and having a center opening in alignment with the generally circular open end of the filter housing; and
securing a cap adapted to be releasably securable to the engagement element of the filter housing opening to retain and conceal the water filter in the filter cavity.

19. The method of claim 18 wherein the step of securing the cap includes facilitating threaded engagement between the cap and the engagement element of the filter housing.

20. The method of claim 18 wherein the step of securing the cap includes facilitating a bayonet-style engagement between the cap and the engagement element of the filter housing.
